(19) United States
(12) Patent Application Publication
(10) Pub. No.: US 2008/0303678 A1
(43) Pub. Date: Dec. 11, 2008

(54) Combination smoke detector, carbon monoxide detector and cellphone

(76) Inventor: Douglas D. McCredy, Keyport, NJ (US)

Correspondence Address: Charles I. Brodsky, 2 Bucks Lane, Marlboro, NJ, 07746, US

(21) Appl. No.: 12/080,559

(22) Filed: Apr. 4, 2008

Related U.S. Application Data
(60) Provisional application No. 60/933,690, filed on Jun. 8, 2007.

(51) Int. Cl. G08B 17/10; H04M 1/00

(52) U.S. Cl. 340/628; 455/556.1

(57) ABSTRACT

A smoke detector, a carbon monoxide detector, and a cellphone are combined into a single device in providing an alarm to a user upon the detection of smoke and/or carbon monoxide in a closed environment.

### CROSS-REFERENCE TO RELATED APPLICATIONS

A Provisional Patent Application covering the invention described herein was filed Jun. 8, 2007, and assigned Ser. No. 60/933,690.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to safety device alarms for user protection, in general, and to the combination of existing technologies in a unitary device which can be easily carried about for the protection of user's in a “closed environment”, in particular.

2. Description of the Related Art

a. Smoke Detectors. As is well known and understood, a smoke detector is a device that detects smoke and issues an alarm to alert nearby people that there is a potential fire. A household smoke detector will typically be mounted in a disk-shaped plastic enclosure about 150 mm in diameter and 25 mm thick, but the shape can vary by manufacturer. Because smoke rises, most detectors are mounted on the ceiling or on a wall near the ceiling. To avoid the nuisance of false alarms, most smoke detectors are mounted away from kitchens. To increase the chances of waking sleeping occupants, most homes have at least one smoke detector near any bedrooms; ideally in a hallway as well as in the bedroom itself.

Smoke detectors are usually powered by one or more batteries but some can be connected directly to household wiring. Often the smoke detectors that are directly connected to household wiring also have a battery as a power supply back-up in case the household wiring goes out. It is usually necessary to replace the batteries once a year to ensure appropriate protection.

Most smoke detectors work by either optical detection or by ionization, but some of them use both detection methods to increase sensitivity to smoke. Smoke detectors may operate alone, be interconnected to cause detectors in an area to sound an alarm if one is triggered, or be integrated into a fire alarm or security system. Smoke detectors with flashing lights are available for the deaf or hearing impaired.

b. Carbon Monoxide Detector. As additionally known and understood, a carbon monoxide detector is a device that detects the presence of the toxic gas carbon monoxide, a colorless and odorless compound produced by incomplete combustion and lethal at high levels. Typically sold for home use, once a high level of carbon monoxide is detected, the device sounds an audible alarm, giving people in the area a chance to ventilate the area or safely leave the building. Such detectors can be placed near the ceiling or near the floor as carbon monoxide is very close to the same density as air.

Since carbon monoxide is colorless and odorless (unlike smoke from a fire), detection in a home environment is impossible without such a warning device. Either battery-operated or AC powered (with or without a battery back-up), once an alarm sounds, action must be taken immediately. This may include evacuating the premises if experiencing carbon monoxide poisoning symptoms (e.g. confusion, headaches, nausea, dizziness, vomiting), ventilation of the premises, or contacting professionals to inspect possible emitting sources.

All carbon monoxide detectors have “test” buttons and, like smoke detectors, should be tested regularly. Since carbon monoxide levels normally increase very slowly, there is a large ratio between safe and unsafe levels, and levels that cause minor and severe symptoms. At lower concentrations, the detector will not sound an alarm for many tens of minutes, while at higher concentrations, the alarm will sound within a few minutes. This concentration-time function is intended to mimic the uptake of carbon monoxide in the body, while also preventing false alarms due to relatively common sources of carbon monoxide such as cigarette smoke.

c. Cellphones. As is also well known and understood, a cellphone (more specifically a “mobile phone” or “cellular telephone”) is a long-range, portable electronic device used for mobile communication. Most current mobile phones connect to a cellular network of base stations (cell sites), which is in turn interconnected to the public switched telephone network.

Mobile phones can obtain power generally from batteries. Batteries can be recharged from mains power, a USB port or a cigarette lighter port in an automobile. The most common form of cellphone batteries are Nickel Metal Hydride—which are ideal for their size and weight, but seem to go dead first if the user does not let them run down all the way before charging them again. The other common type of batteries used are Lithium-Ion, which are lighter and do not have the memory effect that the Nickel Metal Hydride batteries do.

Mobile phones and the network they operate under vary significantly from provider to provider, and nation to nation. However, all of them communicate through electromagnet radio waves with a cell site base station, the antennas of which are usually mounted on a tower, pole or building.

The phones have a low-power transceiver that transmits voice and data to the nearest cell sites, usually not more than 5 to 8 miles away. When the mobile phone or data service is turned on, it registers with the mobile telephone exchange, or switch, with its unique identifiers, and will then be alerted by the mobile switch when there is an incoming telephone call. The handset constantly listens for the strongest signal being received from the surrounding base stations. As the user moves around the network, the mobile device will “handoff” to various cell sites during calls, or while waiting between calls it will reselect cell sites.

Cell sites, on the other hand, have relatively low-power radio transmitters which broadcast their presence and relay communications between the mobile handsets and the switch. The switch in turn connects the call to another subscriber of the same wireless service provider or to the public telephone network, which includes the networks of other wireless carriers. Many of these sites are camouflaged to blend with existing environments, particularly in high-scenery areas.

### SUMMARY OF THE INVENTION

As will become clear from the following description, the present invention combines the smoke detector, carbon monoxide detector and cellphone within a single device, fancifully termed a “SMOKESTER”. This follows from a realization that cellphones are always kept charged by their users while smoke detectors and carbon monoxide detectors frequently have their batteries run down through owner neglect, thereby resulting in their providing less than optimum protection, if at all. It also follows from a realization that many times, while out of the home, the cellphone user might be staying overnight in a hotel, bed and breakfast, boarding house, or cabin which lacks either or both of a smoke detector or carbon monoxide detector—or in other facilities where such detector presence is not required by federal, state or municipal law.

### BRIEF DESCRIPTION OF THE DRAWINGS

These and other features of the present invention will be more clearly understood from a consideration of the following description, taken in connection with the accompanying drawings, in which:

FIG. 1 is a schematic illustration of a combination of a smoke detector, a carbon monoxide detector, and a cellphone into a single device, in accordance with the present invention; and

FIG. 2 is a schematic illustration of a use of the invention in a hotel facility to serve as a guidance in assisting evacuation upon the detection of smoke and/or carbon monoxide by the combination device.

### DETAILED DESCRIPTION OF THE INVENTION

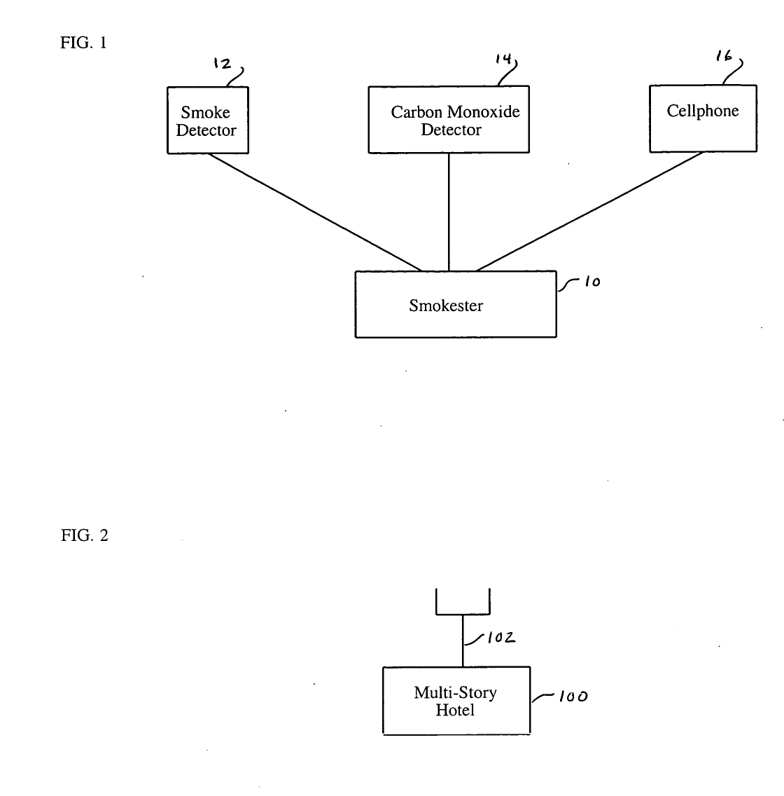

FIG. 1 illustrates any appropriate construction of the myriad component designs of a smoke detector 12, a carbon monoxide detector 14 and a cellphone 16 combined into the single SMOKESTER device of the invention 10. Ever charged and either carried by a user or readily nearby in a closed environment, the combined design could be such as to provide a ringtone to alert the user upon the detection of smoke above a first predetermined level or carbon monoxide above a second predetermined threshold level in the closed environment. Alternatively, the combined design could be such as to provide a voice-alert of the detection, with or without such ringtone, such as “Smoke (or Carbon Monoxide) has been detected in the room, evacuate the premises now!” All such combined SMOKESTER cellphones would have such warnings and advice programmed into their individual constructions. Other technological variations can also keep the combined cellphone in a “STANDBY MODE”, to be turned on automatically to provide the built-in alarm upon detection.

As mobile phone connections to central monitoring stations are well known, an alternative design of the SMOKESTER combination could also alert a central monitoring station upon detection of the smoke or carbon monoxide condition in the closed environment, to allow for the monitoring station to telephone the cellphone user of the condition, or to activate an on-board speaker to additionally produce the warning alert. This type of advance service could be made available by the appropriate service providers (be it SPRINT, CINGULAR, or otherwise), at a nominal monthly fee. Detection of the dangerous condition would then be automatically transmitted via the mobile telephone exchange.

Technology is also available to provide the assistance illustrated in FIG. 2, where reference numeral 100 represents a multi-story hotel provided with a roof antenna 102 operative with a global positioning satellite. As part of the hotel's construction and installation, its floor and exit plans can be programmed in, to work with the SMOKESTER design such that upon receipt of a cellphone communication that a smoke and/or carbon monoxide situation is recognized, appropriate signal information is transmitted by satellite back to the individual cellphone to provide verbal directions as to how to navigate the floors and hallways of the hotel facility to locate the nearest exit stairways and doors. This will be seen to be particularly appropriate to cellphone users who are not familiar with the exiting details of the hotel emergency evacuation plan where the user may then be staying. Such a feature can follow in accordance with adoption of appropriate legislation to require these hotel and like facilities to erect a global positioning antenna and blueprint design of its layout of hall and door emplacements.

While there has been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the invention.

I claim:

1. A mobile warning system comprising:
first means for detecting a smoke condition in a closed environment beyond a first predetermined threshold;
second means for detecting a carbon monoxide condition in a closed environment beyond a second predetermined threshold; and
a cellular phone incorporating said first and second means, programmed to provide at least one of a ringtone or voice alert upon detection by said first or second means of either or both of said thresholds being exceeded.

2. The mobile warning system of claim 1 wherein said cellular phone is programmed to a standby mode of operation.

3. The mobile warning system of claim 2 wherein said voice alert sounds a warning to immediately vacate from the closed environment.

4. The mobile warning system of claim 3 wherein said cellular phone is also programmed to alert a central monitoring station upon detection of either or both of said smoke or carbon monoxide threshold conditions being exceeded.

5. The mobile warning system of claim 4 wherein said cellular phone is additionally programmed to sound a warning to immediately vacate from the closed environment upon receipt of a radio communication from the central monitoring station that either or both of said smoke or carbon monoxide detection thresholds have been exceeded.

6. The mobile warning system of claim 5 wherein said cellular phone is further programmed to display a recommended travel path to vacate from the closed circuit environment upon receipt of the radio communication from the central monitoring station.
